(19) United States
(12) Patent Application Publication
(10) Pub. No.: US 2015/0199755 A1
(43) Pub. Date: Jul. 16, 2015

(54) 3-D PRINTING AUCTION SYSTEM

(71) Applicant: Abraham L.B. Friedman, Chicago, IL (US)

(72) Inventor: Abraham L.B. Friedman, Chicago, IL (US)

(21) Appl. No.: 14/598,585

(22) Filed: Jan. 16, 2015

Related U.S. Application Data
(60) Provisional application No. 61/928,051, filed on Jan. 16, 2014.

(51) Int. Cl. G06Q 30/08; G06F 17/50; B29C 67/00; G06Q 30/06

(52) U.S. Cl. CPC G06Q 30/08; G06Q 30/0613; G06Q 30/0631; G06Q 30/0635; G06F 17/50; B29C 67/0051

(57) ABSTRACT

The invention includes an automated, dynamic system for obtaining 3-D printed products comprising a design database for displaying 3-D print designs; a print shop database for receiving designs; a central website for coordinating receipt of design inquiries, access to print shop and design databases and coordinating an auction; an auction processor for receiving bids for setting a price for a 3-D print design process; and a cash allocator to execute payment transactions in favor of a print shop. The system provides a dynamic customer account web page for providing a central composite location to manage and facilitate the 3-D print services.

This application claims priority to Provisional application Ser. No. 61/928,051, filed Jan. 16, 2014.

### BACKGROUND

3-D printing processes are revolutionizing methods of manufacturing products. While the cost of a 3-D printer is very low, there still is not a need for every household to have its own 3-D printer. It is beneficial to have a skilled technician operating the 3-D print machinery. Such 3-D printer companies can provide cost savings and benefit consumers. Providing access to such 3-D printing manufacturers via the internet is also desirable. However, there is currently no streamlined method of locating designs for desired products and engaging 3-D print manufacturers to complete the manufacturing process.

### SUMMARY

The present invention provides for an automated, dynamic system for obtaining 3-D printed products comprising a design database for displaying 3-D print designs; a print shop database for receiving designs; a central website for coordinating receipt of design inquiries, access to print shop and design databases and coordinating an auction; an auction processor for receiving bids for setting a price for a 3-D print design process; and a cash allocator to execute payment transactions in favor of a print shop. The system provides a dynamic customer account web page for providing a central composite location to manage and facilitate the 3-D) print services.

The present invention provides for a system for creating and serving dynamic web pages for 3-D printed product services, the system comprising an auction server for simultaneously hosting hundreds of customer account web pages and automatically creating customer account web pages, each customer account web page providing a composite web page having general product inquiry data, 3-D print design data and 3-D print shop bid data. The present invention provides for a design database for storing thousands of 3-D print designs, the design database linked to the auction server. An optimization engine is linked to the auction server and design database, the optimization engine programmed to receive a general inquiry from the customer account web page, automatically assign a category to the general inquiry, automatically send the general inquiry to networked forums that match the assigned category, receive product suggestions from the networked forums and automatically insert the product suggestions to the customer account web page and automatically notifying the customer that a response to the general inquiry has been inserted on the customer account web page, and receive a 3-D print design request from the customer based on the product suggestions reviewed by the customer on the customer account web page and automatically link the customer account web page to the design database having 3-D print designs matching the assigned category.

The present invention provides for the auction server programmed to receive a selected 3-D print design from the customer account web page and automatically post on an auction web page the selected 3-D print design for bids from 3-D print shops, receive bids for the selected 3-D print design from 3-D print shops and automatically insert the bids for display on the customer account web page and receive a purchase request from the customer account web page for a 3-D print design order selected by the customer based on the composite customer account web page having general product inquiry data, 3-D print design data and 3-D print shop bid data and automatically forwarding the 3-D print design order to a corresponding 3-D print shop for completing the order.

The present invention provides for an optimization engine that links to a performance analyzer to analyze the product suggestions to rate the comparable performance characteristics of the product suggestions and automatically insert the product analysis to the customer account web page. The optimization engine posts product suggestions from a first group of networked forum members and automatically inviting a second group of networked forum members for forums related to the category to provide comparisons between the product suggestions from the first group of networked forum member and a second product suggestion from the second group of networked forum members. The comparisons include descriptions regarding the desirability and marketability of the second product suggestion.

The present invention provides for 3-D print shop 3-D printer linked to the network and capable of communicating with the optimization engine and the 3-D printer provides project status information and product performance information. A payment allocation server executes payment transaction in favor of the corresponding 3-D print shop upon shipment of the 3-D print design order to the customer and updating the customer account web page indicating completion of the 3-D print design order. The payment allocation server divides the proceeds from the 3-D print design order between the 3-D print shop and a designer of the 3-D print design selected from the 3-D print design database.

The present invention provides for a central composite web page for coordinating receipt of design inquiries, access to 3-D print shops, 3-D design databases and the auction engine. The auction server may automatically select a lowest bid from the 3-D print shops and inserts the lowest bid to the customer account web page. The auction server links the customer account web page to a warranty provider with respect to the selected 3-D print design.

The present invention provides for an optimizing engine that links the customer account web page to multiple 3-D print design databases in order to match the selected 3-D print design including the step of matching at least one of material, color, size and style. The optimizing engine locates 3-D print shops within a specified territory range and a specified transport carrier to ship the selected 3-D print design. The optimizing engine uses an algorithm in order to determine the optimal 3-D print offer based on the composite customer account web page data including general product inquiry data, 3-D print design data and 3-D print shop bid data.

The present invention provides for a system for creating and serving web pages for providing 3-D printed product services, the system comprising an auction engine for hosting customer account web pages and automatically creating customer account web pages, each customer account web page providing a dynamic composite web page having general product inquiry data, 3-D print design data and 3-D print shop bid data. A design library is provided for storing thousands of 3-D print designs, the design library linked to the auction engine. An optimization engine is linked to the auction engine and design library.

The optimization engine may be programmed to receive a 3-D print design request from the customer and automatically link the customer account web page to the design database having 3-D print designs matching the assigned category, link to a performance analyzer to analyze the product suggestions to rate the comparable performance characteristics of the product suggestions and automatically insert the product analysis to the customer account web page.

The auction engine may be programmed to receive a selected 3-D print design from the customer account web page and automatically post on an auction web page the selected 3-D print design for bids from 3-D print shops, receive bids for the selected 3-D print design from 3-D print shops and automatically insert the bids for display on the customer account web page and receive a purchase request from the customer account web page for a 3-D print design order selected by the customer based on the composite customer account web page having 3-D print design data and 3-D print shop bid data and automatically forwarding the 3-D print design order to a corresponding 3-D print shop for completing the order.

The optimization engine further programmed to receive a general inquiry from the customer account web page, automatically assign a category to the general inquiry, automatically send the general inquiry to networked forums that match the assigned category and receive product suggestions from the networked forums and automatically insert the product suggestions to the customer account web page and automatically notifying the customer that a response to the general inquiry has been inserted on the customer account web page.

The present invention provides for the optimization engine to post product suggestions from a first group of networked forum members and automatically inviting a second group of networked forum members for forums related to the category to provide comparisons between the product suggestions from the first group of networked forum member and a second product suggestion from the second group of networked forum members. The comparisons include descriptions regarding the desirability and marketability of the second product suggestion.

The present invention provides further for a payment allocation server for executing a payment transaction in favor of the corresponding 3-D print shop upon shipment of the 3-D print design order to the customer and updating the customer account web page indicating completion of the 3-D print design order.

Another embodiment of the present invention provides for a method for creating and serving web pages for providing 3-D printed product services, the method comprising the steps of, simultaneously hosting hundreds of customer account web pages and automatically creating customer account web pages by an auction server, each customer account web page providing a composite web page having general product inquiry data. 3-D print design data and 3-D print shop bid data, storing thousands of 3-D print designs by a design database linked to the auction server, receiving a 3-D print design request from the customer and automatically linking the customer account web page to the design database having 3-D print designs matching the assigned category, the receiving and linking by an optimization engine linked to the auction server and design database, linking to a performance analyzer and analyzing the product suggestions to rate the comparable performance characteristics of the product suggestions and automatically inserting the product analysis to the customer account web page, the linking and inserting by the optimization engine, receiving a selected 3-D print design from the customer account web page and automatically posting on an auction web page the selected 3-D print design for bids from 3-D print shops, the receiving and posting by the auction server, receiving bids for the selected 3-D print design from 3-D print shops and automatically inserting the bids for display on the customer account web page, the receiving and inserting by the auction server; and receiving a purchase request from the customer account web page for a 3-D print design order selected by the customer based on the composite customer account web page having general product inquiry data, 3-D print design data and 3-D print shop bid data and automatically forwarding the 3-D print design order to a corresponding 3-D print shop for completing the order, the receiving and forwarding by the auction server.

In another embodiment, the invention includes the steps of a customer linking to the 3dPA website and launching a search engine, when making a selection for an overview of various categories of 3d printed items available for purchase on the website. The customer can then search for a specific item and the customer is taken to the next web page featuring a list of results from their search. These results will include a picture of the completed item, name of the product, the designer's store name, and the maximum price a buyer would pay for it. Next the customer may select a category of 3d printed items. If this option is chosen, a similar list will appear, the only difference being that different sub categories will be available above the list of search results, so the customer's broader search can be narrowed down. For example, if “jewelry” is searched, sub categories could be necklaces, earrings, rings, etc.

After a customer selects the item they wish to purchase, they are presented with a few options. First, the customer chooses the material and color they wish their item to be printed in. After this step, the customer decides whether or not they want a warranty on the product and/or if they would like to have it shipped. They are then given the choice to be put in touch with the designer of the product, in case further alterations are needed. If the buyer declines to be put into contact with the designer (which will frequently be the case) then the customer's payment information is added.

After all of the design specifications and payment information is entered into 3dPA, the auction commences. 3dPA's auction processor will use an algorithm to determine the lowest combined price of the product itself, warranty (if desired), and shipping costs. After this is calculated, the buyer receives a notification of the final price to pay based off of the total calculated price from the winning consortium. The buyer's payment goes through and is appropriately distributed to the warranty granter (potentially), the designer of the product, the transportation service (potentially), and 3dPA for facilitating the whole process. Each of these steps is facilitated by a dynamic web page that automatically links to the appropriate parties and forums and builds a customized web page providing all of the above information for the customer.

### BRIEF DESCRIPTION OF THE DRAWINGS

FIG. 1 is a schematic view of the 3-D print process of the present invention;

FIGS. 2a and 2b are flow diagrams describing the 3-D print system of the present invention;

FIGS. 3a and 3b are flow diagrams describing in alternate format the 3-D print method of the present invention;

FIG. 4 is a schematic flow diagram depicting selection of design criteria;

FIG. 5 is a schematic flow diagram depicting selection of design library query system;

FIG. 6 is a schematic flow diagram depicting selection of final design criteria and use of the Auction Engine and Analyzer Engine;

FIG. 7 is a schematic flow diagram depicting selection of warranty, print company and transport each facilitated by the Auction Engine;

FIG. 8 is a schematic flow diagram depicting selection of optimal offer by Auction Engine;

FIG. 9 is a schematic flow diagram depicting selection of an offer to customer:

FIG. 10 is a schematic flow diagram depicting selection by 3-D PA website of offer;

FIG. 11 is a sample screen-shot of the 3-D PA website data entry screen;

FIG. 12 is a sample screen-shot of the 3-D PA website dashboard depicted final status; and

FIG. 13 is a schematic view of the hardware of the present system.

While the invention is amendable to various modifications and alternate forms, specific embodiments have been shown by way of example in the drawings and will be described in detail, it should be understood that the intention is not limit the invention to the particular embodiments described. The intention is to cover all modifications, equivalents and alternatives falling within the spirit and the scope of the invention. While the invention is amendable to various modifications and alternate forms, specific embodiments have been shown by way of example in the drawings and will be described in detail, it should be understood that the intention is not limit the invention to the particular embodiments described. The intention is to cover all modifications, equivalents and alternatives falling within the spirit and the scope of the invention.

### DETAILED DESCRIPTION

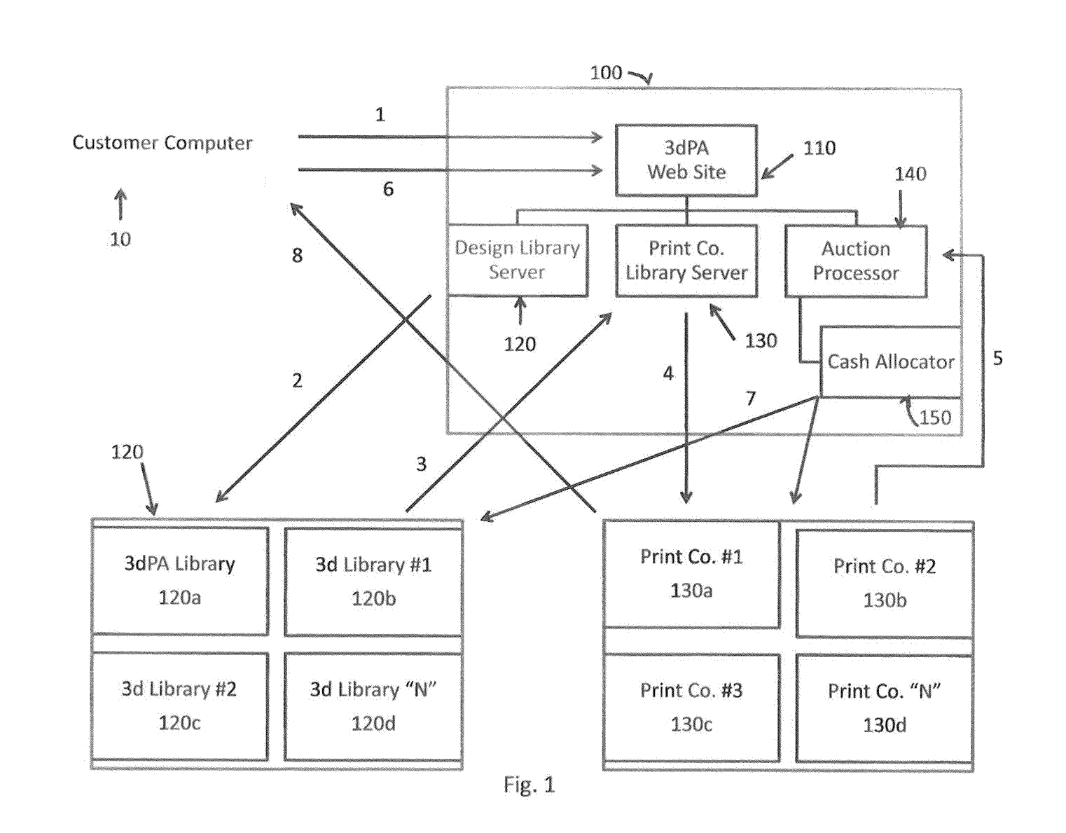

An embodiment of the present invention will be described with respect to FIGS. 1-13. Turning to FIG. 1, a customer's computer 10 will be used to access the internet 100. At step 1 the customer's computer browser links to the 3-D PA (3-D printing auction) website 110. Via the 3-D PA website 110, access is provided to a design library server 120. The design library data may be organized in well-known means of organizing different types of data, products and services. For example, different categories of products may be listed alphabetically and subcategories may be found by clicking on each of the subcategories. In an embodiment, the design library may obtain commissions as an allocation from the purchase price. Other means of remuneration may be provided to the 3-D PA website when designs are chosen.

As shown in FIG. 1 the design library 120 may have a standard library 120a or subcategories through library one 120b, library two 120c or other exponential number (“n”) of “3-D libraries” at 120d. In an embodiment, the 3-D library 120a may provide a listing of the most popular designs for that month being selected by consumers. Other means of organizing the products provided by the libraries, may be included such as by price, range, length of time to manufacture, holidays such as Valentines, Christmas, Mother's Day. Father's Day, etc. or by season.

After step 2 is followed and a design is chosen by the design library server 120, the design is transmitted in step 3 to the print company library server 130. Transmission of the design to the print company library server may be accomplished automatically once the consumer selects the design as a pre-selected print company may be designated for each specific design. Or in an alternative embodiment, the consumer may use the 3-D PA website 110 to choose from an assortment of print companies 130. Print companies may be identified on the 3-D PA website by designating previous customer's satisfaction levels or by location. For example, consumers in the United States who want to have their products made in the United States may locate U.S. 3-D print companies. So as shown in FIG. 1, print company one 130a, print company two 130, print company three 130c and print company “n” 130d may all be displayed on a 3-D PA website. In an embodiment, the print company will pay the 3-D PA website for each of the listings on the websites and/or for the clicks it receives inquiring about their print company capabilities.

At step 4 any 3-D print company may submit a response to a request for pricing (RFP) to complete the manufacture of the product selected from the 3-D library 120. If the consumer chooses an auction process, she may implement the auction process module 140 to locate the lowest priced 3-D print manufacturer. The consumer will post their desired product on the 3-D PA website and capable print companies will line-up for the auction process using the auction processor module 140. In an embodiment, the auction processor module 140 may receive identification information from each of the bidding print companies. The auction process may take place over a matter of hours or days.

In an preferred embodiment, the auction is a reverse auction process (“Dutch”) where the bidding starts high and goes lower, so that the consumer receives the lowest price to manufacture the desired product. In an embodiment, the consumer may post the starting bid price to complete the product. In an alternate embodiment, one of the print companies may enter the starting bid and other print companies may thereafter submit subsequent and lower bids. The 3-D PA website will post auction rules identifying specific timing of the auction bidding and increments of bidding and information that must be obtained by the print companies and the consumer. Specific rules will be provided by the 3-D PA website to prohibit collusion amongst print companies to avoid price fixing and collusion amongst the print companies so that fair bidding occurs and the consumer actually is receiving the lowest price available. In an alternate embodiment the consumer may select 3-D print company 1-n 130a-130d without an auction. In a further alternate embodiment, other price exploration means may be provided such as selection of a price by a neutral, comparison shopping to similar products, primary auction, scaled first-price auction, Vickery auction; all pay auction or buyout auction.

At step 5, once the print companies 130a, b, c, d, have submitted the appropriate bids and the time for the auction is closed, the consumer will be advised of the winning bid. In an embodiment, the consumer will automatically have their account charged through the cash allocator module 150 and via step 7 the print company and the library companies will be paid by the consumer for the completion of the order. In an alternate embodiment, the consumer may review the final bid and decide whether to accept or deny the bid. Upon acceptance of the bid, the cash allocation module 150 will allow for payment to the print company or the design library company via step 7. Payment systems such as PayPal® or Google® Wallet or standard credit card transactions may be used to complete the payment transaction.

Upon completion of the payment, the print company selected will notify the customer of the details of the product manufacturing process, including the date of delivery. At step 8 the print company will deliver the desired product to the consumer.

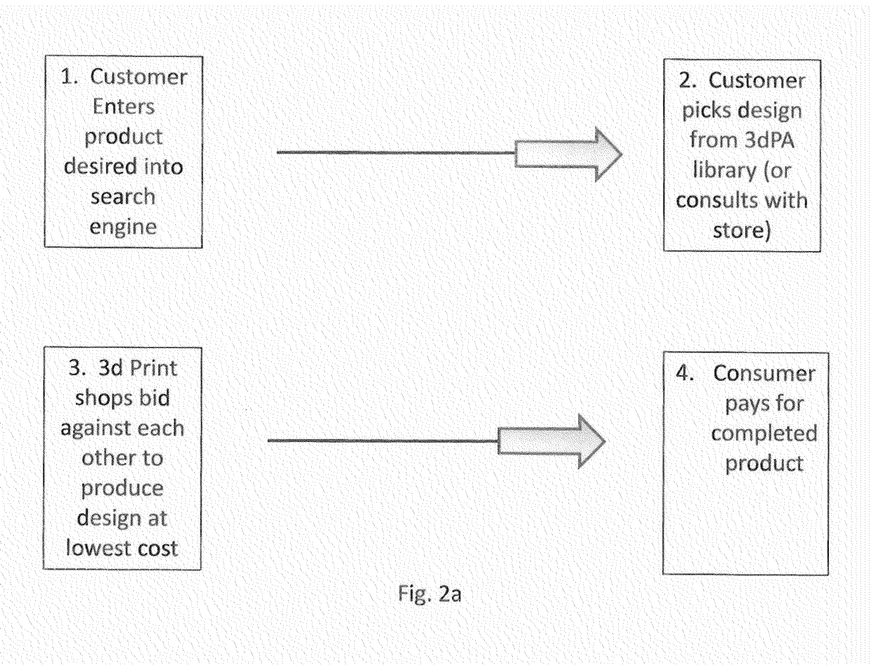

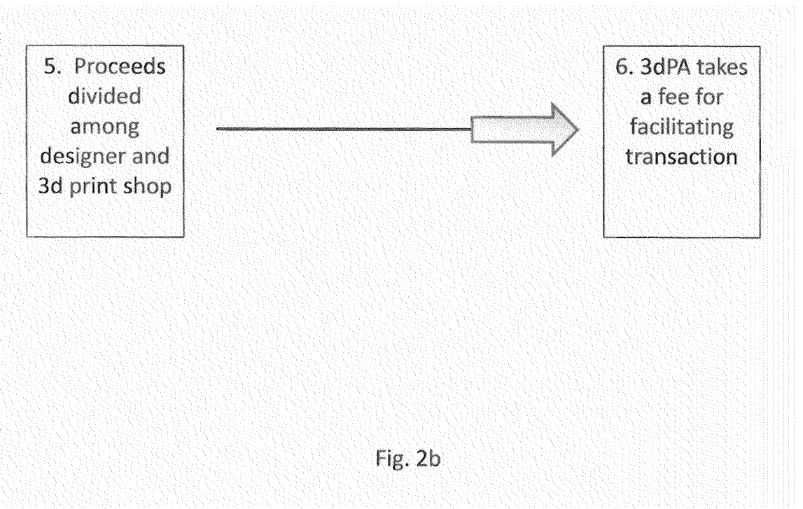

FIG. 2a-b summarizes the method of filling a 3-D print order comprising a first step where a customer links to 3-D PA website 110 and enters the identification of a product (e.g. a generic term for a product is typed into a search bar) entered into a search engine of on the design server library 120. At step 2 the consumer picks a design server/library from the 3-D PA library. In an alternate embodiment, the consumer may use a telephone or enter a “brick and mortar” store and select a design and select its catalogue number or SKU number. At step 3, the 3-D print shops will use the auction processor 140 and will bid against each other two win the auction, providing the lower cost for the consumer. At step 4 the consumer pays for the completed product from the 3-D print shop using for example the cash allocator 150.

Turning to FIG. 2b at step 5, the proceeds submitted by the consumer are divided among the designer library 120 and the 3-D print shop according to predetermined agreements posted on the 3-DPA website. At step 6 the process concludes when 3-D PA website takes its fee for facilitating the transaction.

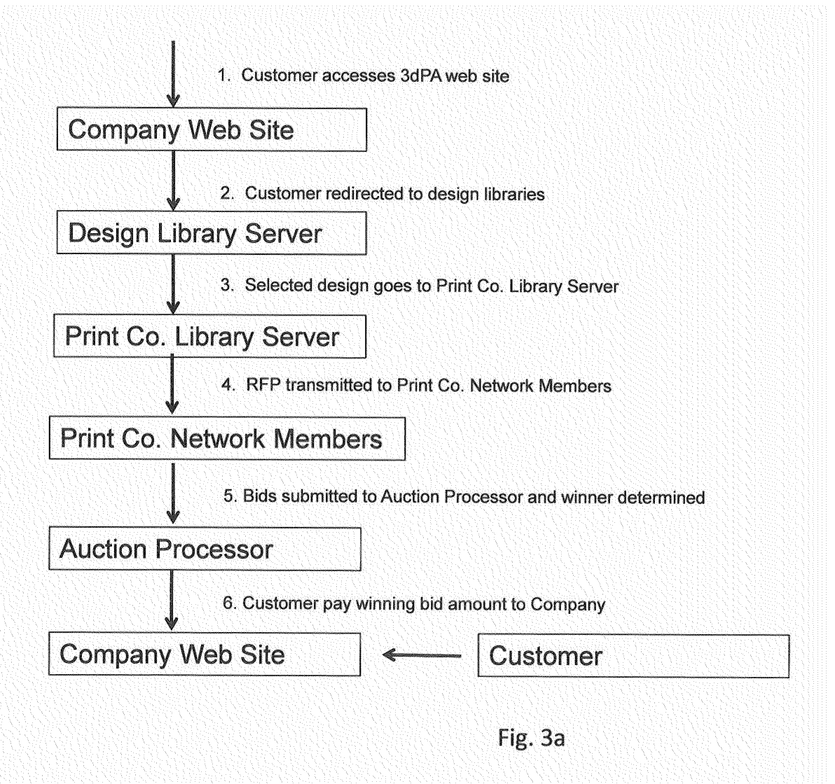

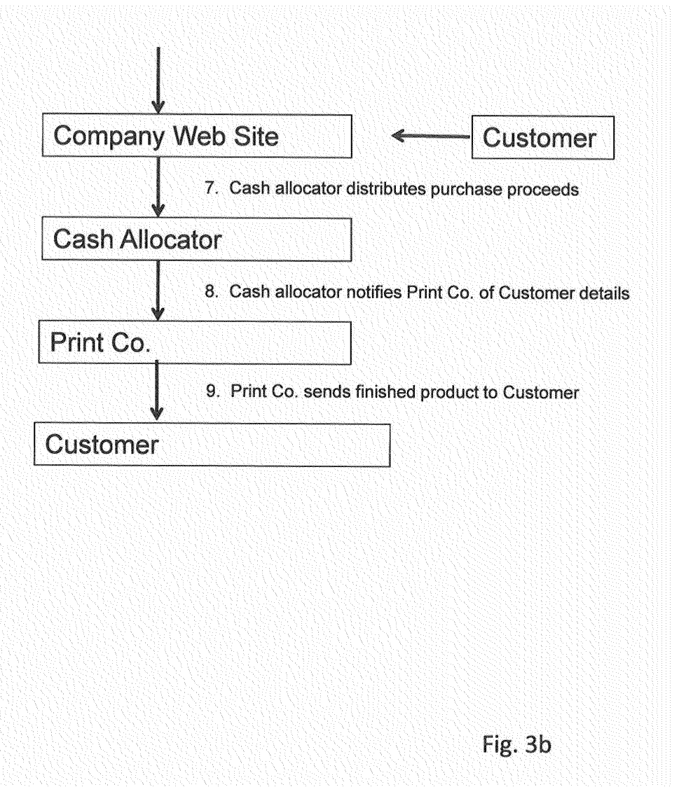

A similar process as discussed above is depicted with respect to FIGS. 3a-b. In addition to the above described process, FIG. 3a identifies at step four that a request for pricing (RFP) is used to trigger a response from print companies in order to participate in the auction and submit bids to complete the manufacturing of the selected design.

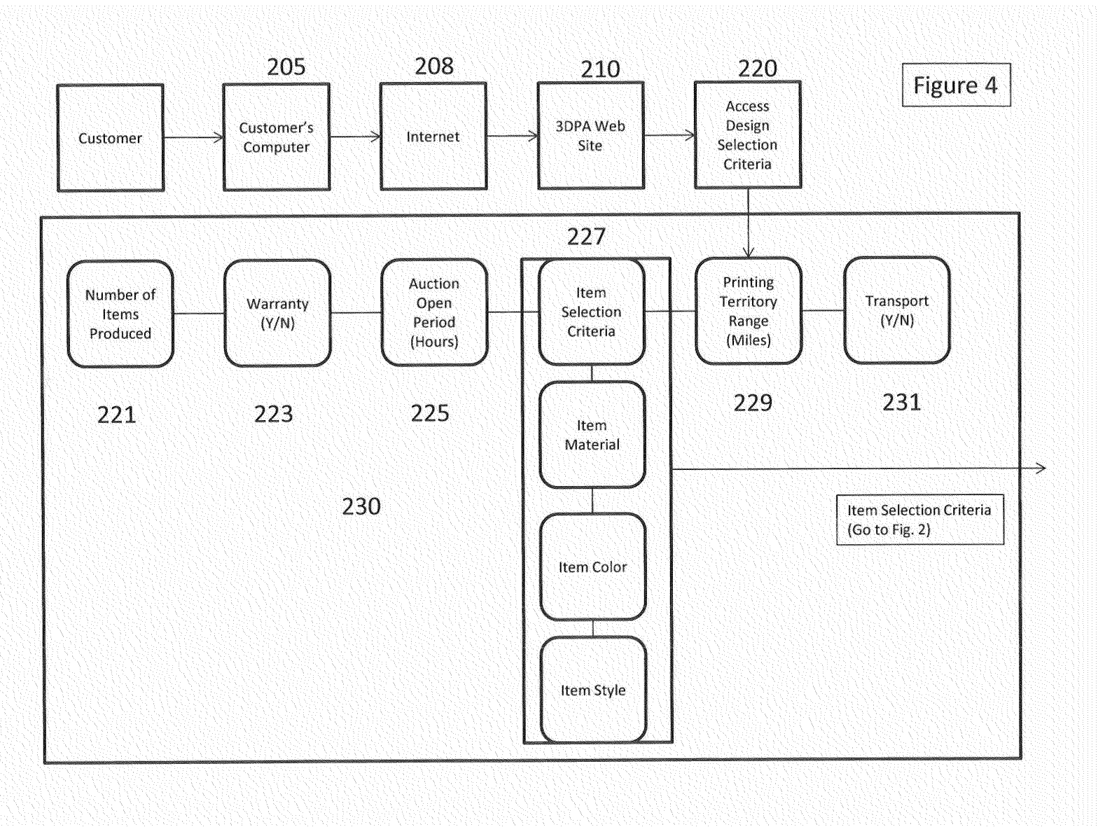

An alternate embodiment of the present invention will be described with respect to FIGS. 4-10. Turning to FIG. 4, a customer's computer 205 will be used to access the Internet 208. At Step 1, the customer's computer browser links through the Internet to the 3-D PA (3-D printing auction) website 210. At 3-D PA's web site, the customer is presented with a series of criteria from which selections are made that establish the parameters of the product to be manufactured 220. On the web site's manufactured product criteria (“MPC”) selection page 230, the customer reviews the criteria that determine the parameters of the product being commissioned for production. Selections relating to Number of Items Produced 221, Warranty 223, Auction Open Period 225, Item Selection Criteria 227, Printing Territory Range 229 and Transport 231 are made, recorded and readied for transmission to 3-D PA's Design Library Query System (the “DLQS”).

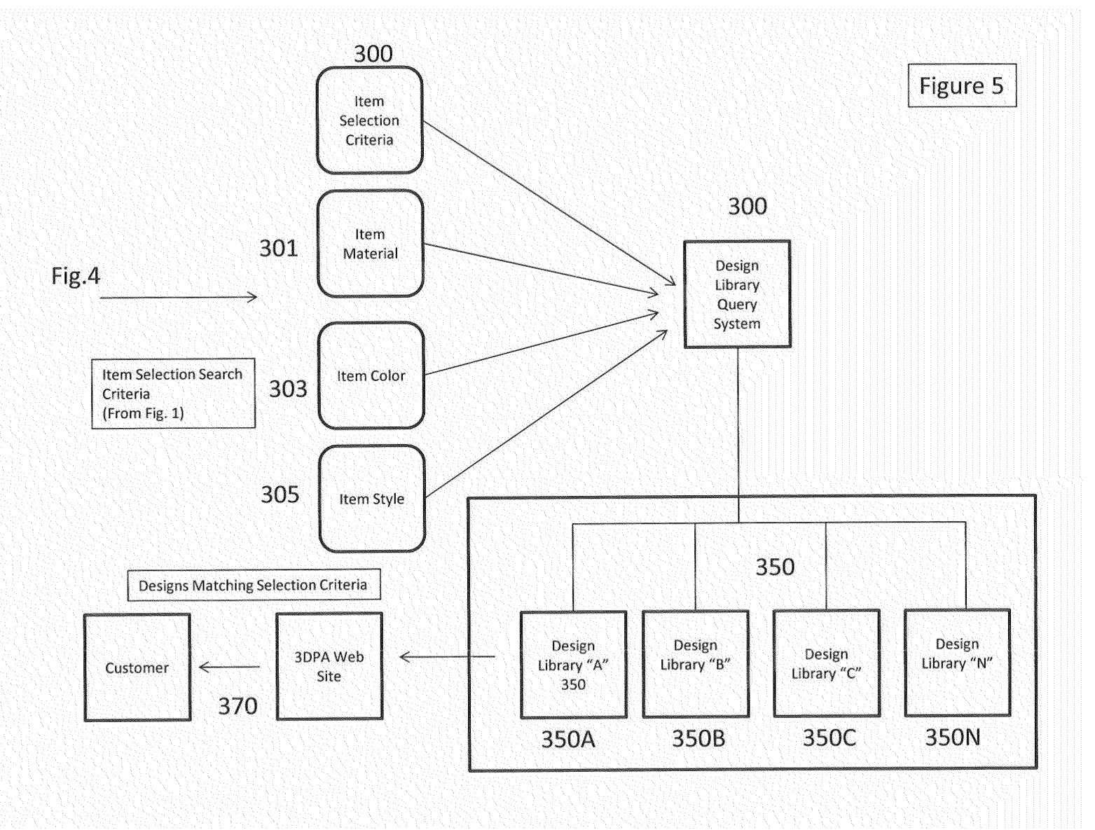

At Step 2 (FIG. 5), Item Selection Criteria 300 (e.g., materials 301, color 303, and architectural style 305) are loaded into the “DLQS (300). The DLQS router communicates the Item Selection Criteria to each of the networked design libraries 350 and search results meeting the specified design criteria 370 are routed back to the customer via the 3-D) PA website.

The design library data may be organized into well-known means of organizing different types of data, products and services. For example and not by way of limitation, different categories of products may be listed alphabetically and subcategories may be found by clicking on each of the subcategories. In an embodiment, the 3-D PA website may obtain commissions from the design library server websites each time a category is selected/clicked. Other means of remuneration may be provided to the 3-D PA website when designs are chosen.

In an embodiment, it is anticipated that design libraries will be able to affiliate with 3-D PA and join the design library network through an automated subscription system. Standard contract terms will be provided on the web site and design libraries can opt into the network if they accept admittance on the posted terms. Any design library that opts into the network will have its contents displayed on the DLQS and becomes eligible for inclusion in the 3-D PA solution and can be manufactured/printed into a final, deliverable product.

A design library, each at 350, may have a standard library structure or subcategories through library one 350A, library two 350B or other exponential number (“n”) of “3-D libraries” at 350N. In an embodiment, the 3-D library Access Design Selection Criteria page 220 may provide a listing of the most popular designs for that month being selected by consumers. Other means of organizing the products provided by the libraries may, for example, include price range, length of time to manufacture, holiday specials such as Valentines, Christmas, Mother's Day, Father's Day, etc. or by season.

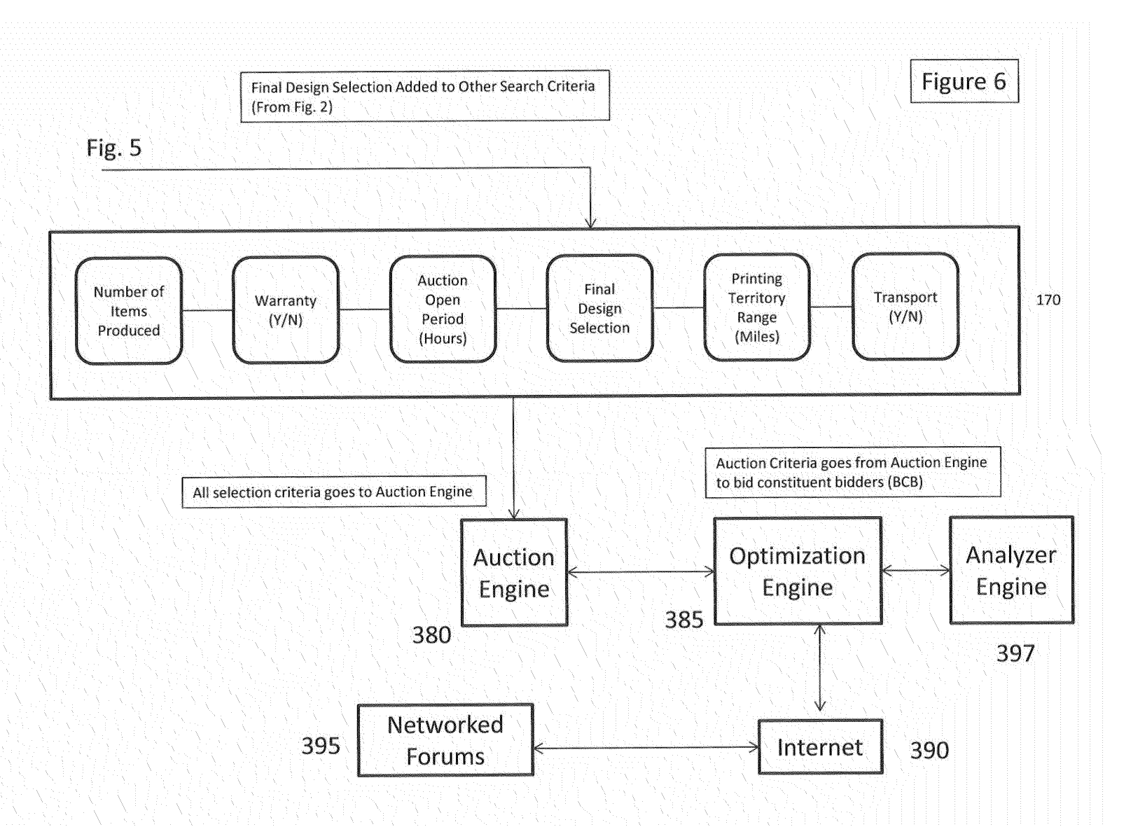

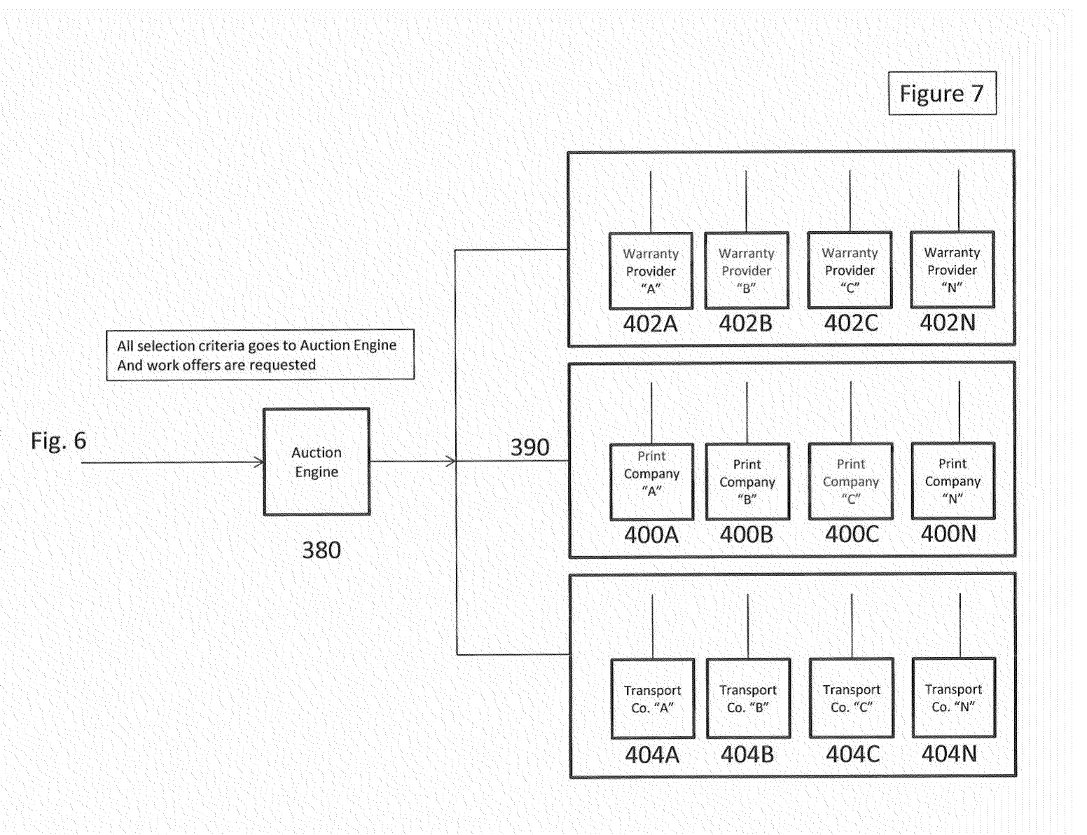

At Step 3 (FIG. 6), customer makes final design selections and those selections, when coupled with all other MPC 370 are forwarded to 3-D PA's Auction Engine 380. Transmission of the design and all bid criteria to the auction engine 380 may be accomplished automatically via the 3-D PA web site or can be entered manually by 3-D PA personnel once the consumer selects the MPC. Pre-selected service providers may be designated for each specific element of the product production process.

In an alternate embodiment the auction engine 380 links to an optimization engine 385 that links to the interface 340 and network forums 395. This embodiment provides a method for creating and serving web pages for providing 3-D printed product services, the method comprising the steps of simultaneously hosting hundreds of customer account web pages 210 and automatically creating customer account web pages 210 by an auction server 380, each customer account web page 210 providing a composite web page having general product inquiry data, 3-D print design data and 3-D print shop bid data. The library 350 serves thousands of 3-D print designs by a design database linked to the auction server 380. The optimization engine 385 receives a 3-D print design request from the customer and automatically linking the customer account web page 210 to the design database 350 having 3-D print designs matching the assigned category, the receiving and linking by an optimization engine 385 linked to the auction server 380 and design database.

The optimization engine 385 links to a performance analyzer 397 and analyzing the product suggestions to rate the comparable performance characteristics of the product suggestions and automatically inserting the product analysis to the customer account web page 210, the linking and inserting by the optimization engine 385. The auction server 380 receiving a selected 3-D print design from the customer account web page 210 and automatically posting on an auction web page 210 the selected 3-D print design for bids from 3-D print shops 400, the receiving and posting by the auction server 380.

Then the auction server 380 receives bids for the selected 3-D print design from 3-D print shops 400 and automatically inserting the bids for display on the customer account web page 210, the receiving and inserting by the auction server 380. The auction server 380 receives a purchase request from the customer account web page 210 for a 3-D print design order selected by the customer, based on the composite customer account web page 210 having general product inquiry data, 3-D print design data and 3-D print shop bid data and automatically forwarding the 3-D print design order to a corresponding 3-D print shop 400 for completing the order, the receiving and forwarding by the auction server 380.

For example, imagine an automobile engine used by a hot rodder. Imagine the hot rodder wants to improve the performance of his car. He queries the 3dPA web site optimization engine 385 asking, “how do I enhance the performance of my '63 Corvette.” The web site optimization engine 385 links via the internet 390 to various hot rodder networked forums 395, after market hot rod shops and the original manufacturer, Chevrolet.

The hot rodder then decides which of these modifications he wants to make to his car. Let's assume he chooses to change carburetors. The hot rodder using the optimization engine 385 then queries what carburetors will work with my engine block? 3dPA optimization engine 385 returns a (i) list of stock carburetors and (ii) a listing of carburetors specifications that will work with the car via the networked forums 395. Once a carburetor is selected, the 3dPA web site and auction engine 380 then automatically link the hot rodder to its design library 350, A,B,C,N. (FIG. 5) and the original 3dPA process begins. The 3dPA web site and optimization engine 385 may also make recommendations of complimentary part modifications that can further enhance engine performance.

In a further implementation, the web site can link to a performance analyzer engine 397 to help the hot rodder understand the effect of each modification he is making to the engine. In another example, a customer knows he want to make his room brighter. He queries 3dPA optimization engine 385 asking, “How do I make my room brighter without creating excessive shadows.” The web site optimization engine 385 and performance analyzer engine 397 takes him through a comparison of LED, incandescent and fluorescent and helps the buyer weigh alternatives. Once the type of lighting is selected, the web site goes to step 7 above to use the auction engine 380 to obtain the lighting 3-D printed product.

The hot rodder's decision is based, in significant part, on the feedback he received from the hot rodder for a, etc., in step 3 above. The original questions, any fora dialogs and other materials that informs the buyers decision maker's buying process are distributed to all participants in step 3. With this knowledge, the participants are able to modify their forum responses to enhance the desirability/marketability of their products. For example, a cam shaft designer knowing carburation was selected for performance enhancement, will post a comparison of performance enhancement between carburetor alternatives and different cam designs proving that had his alternative been selected greater performance enhancement could have been achieved.

In addition to the above described process, in another embodiment has a request for pricing (RFP) to trigger a response from service providers in order to participate in the auction and submit bids to complete the manufacturing of the selected design.

Through this example, we are expanding or building in an element of upselling/cross-selling. Rather than simply being a site to access designs, it has a front-end optimization engine that helps determine optimal technology and related technologies that can be purchased and 3D printed to more efficiently achieve an objective.

At Step 4 (FIG. 7) in an alternative embodiment, the consumer may use the 3-D PA website 210 to choose from an assortment of service providers, e.g, Warranty Providers, Print Companies 400 A,B,C,N and warranty providers 402 A,B,C,N and Transport Companies 400 A,B,C,N who will receive a request for proposal to bid on the opportunity to provide services to an aggregated bid 390.

Service levels may be identified on the 3-D PA website by designating previous customer's satisfaction levels or by location, etc. For example, consumers in the United States who want to have their products made in the United States may locate U.S. 3-D print companies. So, as shown in FIG. 7, for example, Print Company A 400A, Print Company B 400B, Print Company C 400C and Print Company “N” 400N may all be displayed on a 3-D PA website. Selection of Warranty Provider 402 A,B,C,N and Transport Companies 404 A,B,C,N may also be facilitated by the Auction Engine 380. A customer may elect to exclude certain service providers from inclusion in an aggregated bid. In an embodiment, the print company will pay the 3-D PA website for each of the listings on the websites and/or for the clicks it receives inquiring about their print company capabilities.

Optimization Algorithm

At FIG. 5 (Step 8) the Auction Engine 380 selects service providers (i.e., one each of a Print Company 400 A,B,C,N, a Warranty Provider 402 A,B,C,N and a Transport Company 404 A,B,C,N) who, pursuant to their service provision bid price, aggregate to provide to Customer the smallest aggregate purchase price for the requested product. If the Customer chooses an auction process, she may implement the Auction Engine module 380 to locate the lowest priced service providers using an algorithm that considers bid price, delivery time, warranty provisions, distance of transport and other relevant parameters. The consumer will post their desired product on the 3-D PA website and capable service providers will line-up for the auction process using the Auction Engine 380. In an embodiment, the Auction Engine 380 may receive identification information from each of the bidding print companies 400 A,B,C,N. The auction process may take place over a matter of seconds, hours or days.

In a preferred embodiment, the auction is a reverse auction process (“Dutch auction”) where the bidding starts high and goes lower, so that the Customer receives the lowest price to manufacture the desired product. In an embodiment, the Customer may post the starting bid price to complete the product. In an alternate embodiment, one of the print companies or other service providers may enter the starting bid and other print companies or other service providers may thereafter submit subsequent and lower bids. The 3-D PA website 220 will post auction rules identifying specific timing of the auction bidding and increments of bidding and information that must be obtained by the print companies and the consumer. Specific rules will be provided by the 3-D PA website to prohibit collusion amongst print companies to avoid price fixing and collusion amongst the print companies so that fair bidding occurs and the Customer actually is receiving the lowest price available. In an alternate embodiment the Customer may select specific service providers without an auction. In a further alternate embodiment, other price exploration means may be provided such as selection of a price by a neutral, comparison shopping to similar products, primary auction, sealed first-price auction, Vickery auction, all pay auction or buyout auction.

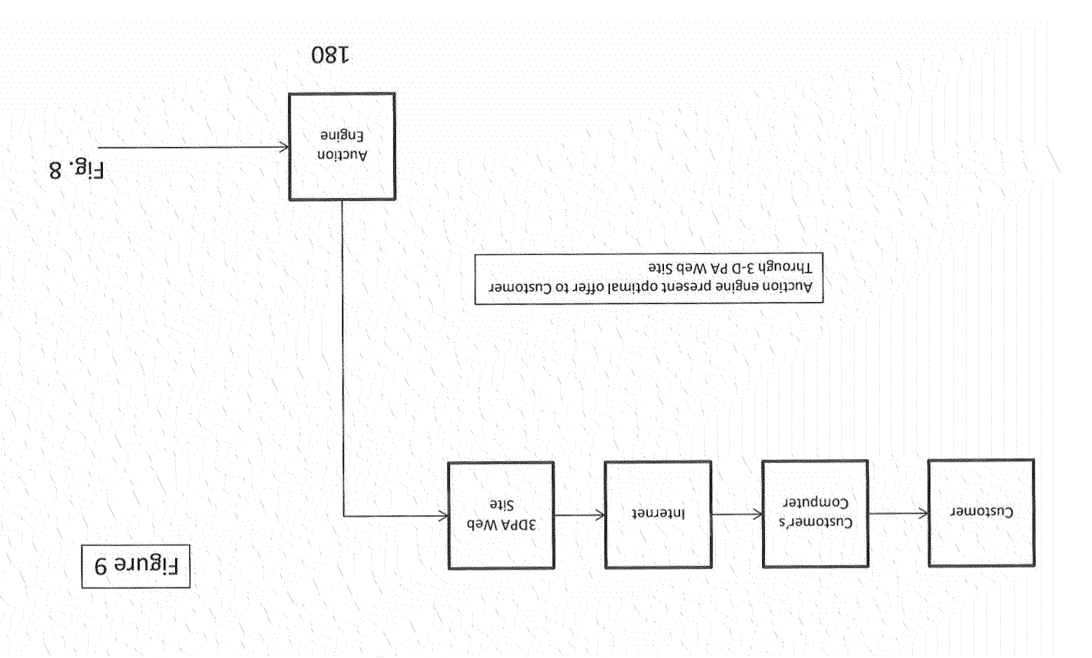

At Step 6 (FIG. 9), once service providers, have submitted the appropriate bids, the time for the auction is closed and the Auction Engine 380 has determined the aggregate best (i.e., lowest) bid, the consumer will be advised of the winning bid via the 3-D PA web site.

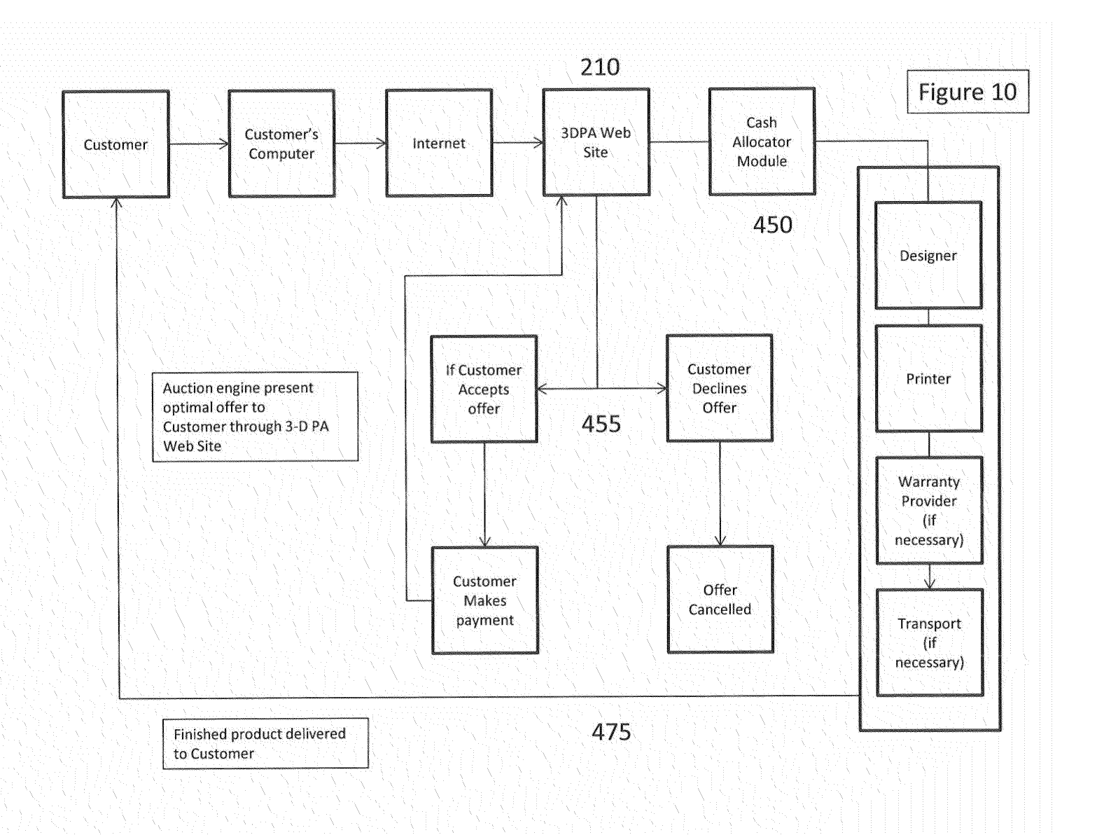

In an embodiment, the consumer will automatically have their account charged through the cash allocator module 450 and via Step 7 (FIG. 10) the service providers and the library companies will be paid by the consumer for the completion of the order. In an alternate embodiment, the consumer may review the final bid and decide whether to accept or deny the bid 455. Upon acceptance of the bid, the cash allocation module 450 will allow for payment to the service providers via Step 7 (FIG. 10). Payment systems such as PayPal® or Google® Wallet or standard credit card transactions may be used to complete the payment transaction.

Upon completion of the payment, the print company selected will notify the customer of the details of the product manufacturing process, including the date of delivery 475. At step 7 the print company will deliver the desired product to the consumer.

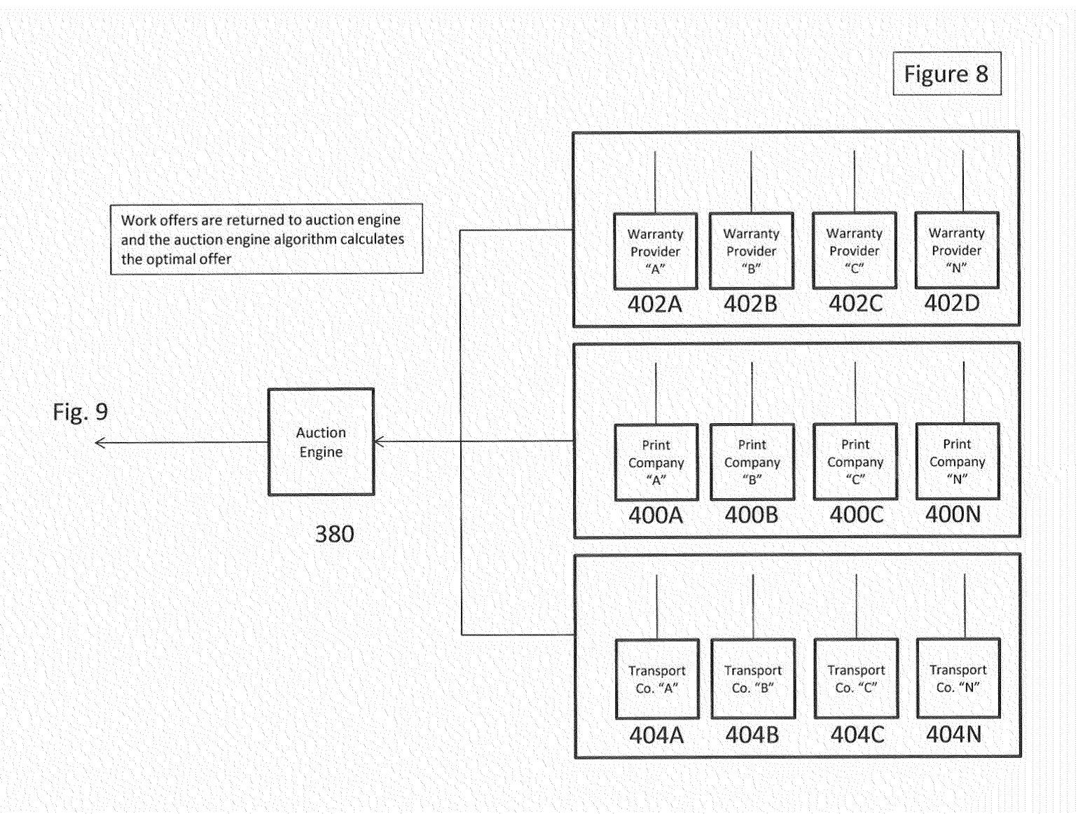

FIG. 5 summarizes the method of filling a 3-D print order comprising a first step where a customer links to 3-D PA website 210 and enters the identification of a product (e.g. a generic term for a product is typed into a search bar) entered into a search engine of on the design server library 350 A,B,C,N. At Step 2 the consumer picks a design server/library from the 3-D PA library. In an alternate embodiment, the consumer may use a telephone or enter a “brick and mortar” store and select a design and select its catalogue number or SKU number. At step 3, the 3-D print shops will use the Auction Engine 380 (FIG. 8) and will bid against each other to win the auction, providing the lower cost for the consumer. At Step 7 the consumer pays for the completed product from the 3-D print shop using for example the cash allocator 450 (FIG. 10).

Turning to FIG. 10 at Step 7, the proceeds submitted by the consumer are divided among the service providers according to predetermined agreements posted on the 3-DPA website. At Step 7 the process concludes when 3-D PA website takes its fee for facilitating the transaction.

A similar process as discussed above is depicted with respect to FIGS. 3a-b. In addition to the above described process, FIG. 3a identifies at step four that a request for pricing (RFP) is used to trigger a response from print companies in order to participate in the auction and submit bids to complete the manufacturing of the selected design.

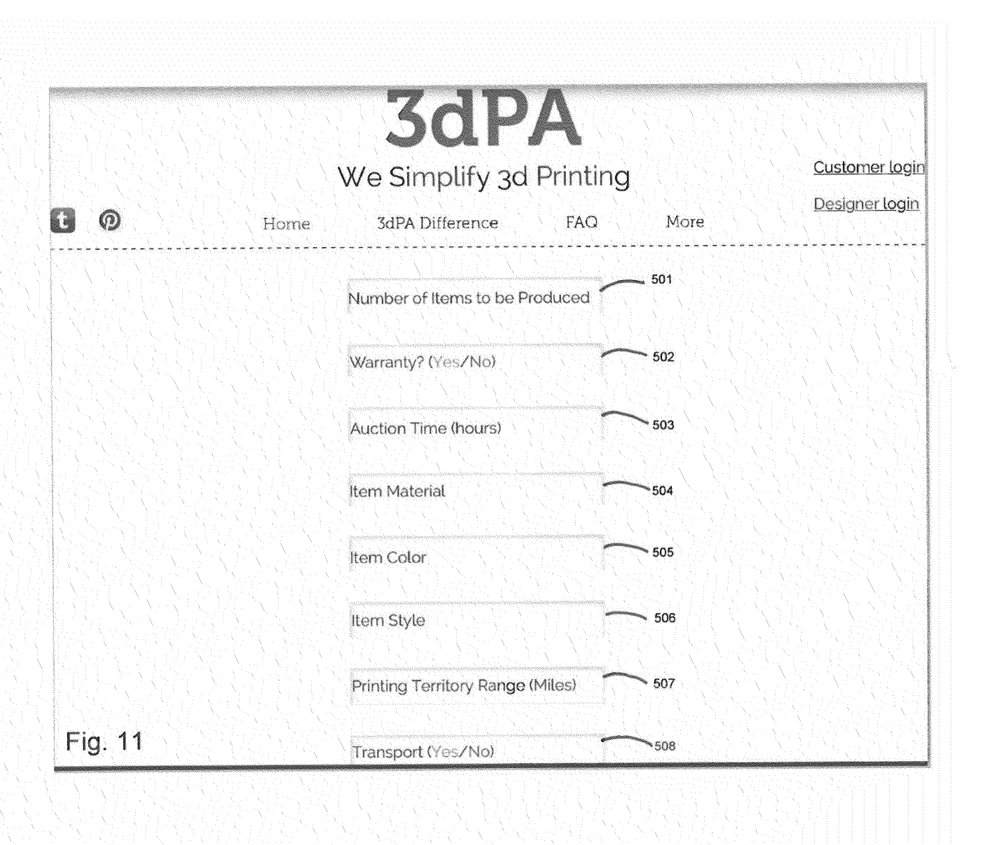

Turning to FIG. 11, a sample screen shot is provided of a data input page where fields are provided to receive the following items: number of items to be produced 501, warranty to be obtained 502, auction time duration in hours 503, item material 504, item color 505, item style 506, printing territory range from customer in miles 507 and whether transportation services are requested 508.

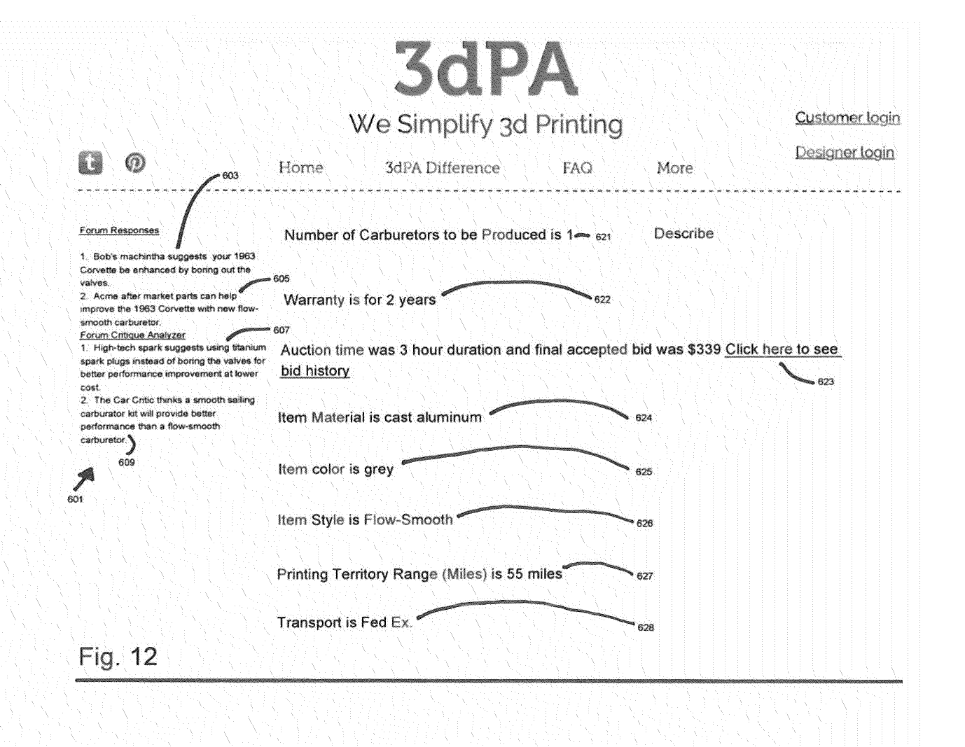

Turning to FIG. 12, a sample screen shot of the customer's dashboard is provided. In the left column 601 Forum Responses and Forum Critique Analyzer depict the dynamic ability of the web page to use the optimization engine 385 linked to the auction server 380 and design database 120 to receive a general inquiry from the customer account web page (FIG. 11), automatically assign a category to the general inquiry, automatically send the general inquiry to networked forums (e.g. after market automobile parts and services) that match the assigned category, receive product suggestions from the networked forums and automatically insert the product suggestions to the customer account web page 603, 605 and automatically notifying the customer that a response to the general inquiry has been inserted on the customer account web page.

At the customer's option, she may link to a performance analyzer engine 397 to analyze the product suggestions 603, 605 to rate the comparable performance characteristics of the product suggestions and automatically insert the product analysis to the customer account web page 607, 609. Following receipt of such forum responses and product analysis, a customer chooses the component of the 3D print design and following the auction process the dashboard web page (FIG. 12) displays the resulting selections including: number of items to be produced is one 621, warranty to be obtained is for two years 622, auction time duration in hours is three and final bid was $339 with a link to the bid history 623, item material is cast aluminum 624, item color is silver 625, item style is Flow Smooth 626, printing territory range from customer in miles is fifty five 627 and Fed Ex transportation services are requested 628.

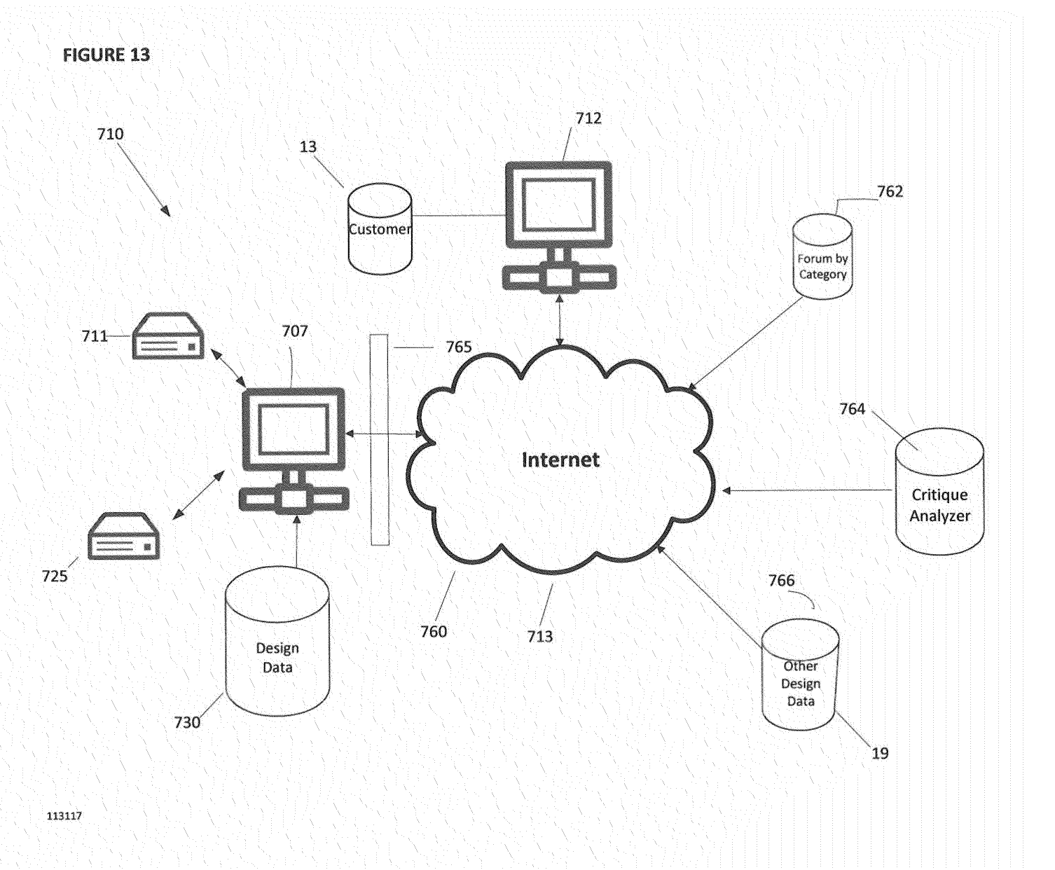

FIG. 13 depicts the hardware such as computers and servers and the internet that control the present invention. The system 710 includes an auction server 711, connected via webserver 707 to the internet 713. The auction server 711 and optimization engine 725. Databases 730 maintain the trading information settled, transferred, delivered, filed, optimized contract data. External users of the system may access the system via computer 712 or mobile devices such as smartphones or tablets via the internet 713. The information transmitted by the external users (e.g. customers, shippers, carriers, etc.) may be saved in a cloud server or database 760. External communications may be received from on-line forums 762 accessed by category requested from the customer, critique analyzer data 764 and other design databases 766. A firewall 765 provides secure transmissions into the system using systems such as Apache Tomcat or Apache Hadoop or similar software. Communication between systems may occur by standard internet protocol, Ethernet or other telecom or wireless transmission means.

Therefore, it is understood that the combination of these components and systems as a complete system will allow for the quick and efficient selection of new products and manufacture of products for consumers.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. For example, numerical values are illustrative rather than limiting, as are disclosures of specific standards, technologies, or brands. It is to be understood that this invention is not limited to the particular embodiments described herein, but is intended to include all changes and modifications that are within the scope and spirit of the invention, which should therefore be construed as limited only by the appended claims.

What is claimed is:

1. A system for creating and serving dynamic web pages for 3-D printed product services, the system comprising:
a) an auction server for simultaneously hosting hundreds of customer account web pages and automatically creating customer account web pages, each customer account web page providing a composite web page having general product inquiry data, 3-D print design data and 3-D print shop bid data;
b) a design database for storing thousands of 3-D print designs, the design database linked to the auction server;
c) an optimization engine linked to the auction server and design database, the optimization engine programmed to:
i) receive a general inquiry from the customer account web page;
ii) automatically assign a category to the general inquiry;
iii) automatically send the general inquiry to networked forums that match the assigned category;
iv) receive product suggestions from the networked forums and automatically insert the product suggestions to the customer account web page and automatically notifying the customer that a response to the general inquiry has been inserted on the customer account web page;
v) receive a 3-D print design request from the customer based on the product suggestions reviewed by the customer on the customer account web page and automatically link the customer account web page to the design database having 3-D print designs matching the assigned category;
d) the auction server programmed to:
i) receive a selected 3-D print design from the customer account web page and automatically post on an auction web page the selected 3-D print design for bids from 3-D print shops;
ii) receive bids for the selected 3-D print design from 3-D print shops and automatically insert the bids for display on the customer account web page; and
iii) receive a purchase request from the customer account web page for a 3-D print design order selected by the customer based on the composite customer account web page having general product inquiry data, 3-D print design data and 3-D print shop bid data and automatically forwarding the 3-D print design order to a corresponding 3-D print shop for completing the order.

2. The system of claim 1, wherein the optimization engine links to a performance analyzer to analyze the product suggestions to rate the comparable performance characteristics of the product suggestions and automatically insert the product analysis to the customer account web page.

3. The system of claim 1, wherein the optimization engine posting product suggestions from a first group of networked forum members and automatically inviting a second group of networked forum members for forums related to the category to provide comparisons between the product suggestions from the first group of networked forum member and a second product suggestion from the second group of networked forum members.

4. The system of claim 3, wherein the comparisons include descriptions regarding the desirability and marketability of the second product suggestion.

5. The system of claim 1, wherein the 3-D print shop 3-D printer is linked to the network and capable of communicating with the optimization engine and the 3-D printer provides project status information and product performance information.

6. The system of claim 1, further comprising a payment allocation server for executing a payment transaction in favor of the corresponding 3-D print shop upon shipment of the 3-D print design order to the customer and updating the customer account web page indicating completion of the 3-D print design order.

7. The system of claim 6, wherein the payment allocation server divides the proceeds from the 3-D print design order between the 3-D print shop and a designer of the 3-D print design selected from the 3-D print design database.

8. The system of claim 1, further comprising a central composite web page for coordinating receipt of design inquiries, access to 3-D print shops, 3-D design databases and the auction engine.

9. The system of claim 1 wherein the auction server automatically selects a lowest bid from the 3-D print shops and inserts the lowest bid to the customer account web page.

10. The system of claim 1 wherein the auction server links the customer account web page to a warranty provider with respect to the selected 3-D print design.

11. The system of claim 1 wherein the optimizing engine links the customer account web page to multiple 3-D print design databases in order to match the selected 3-D print design including the step of matching at least one of material, color, size and style.

12. The system of claim 1 wherein the optimizing engine locates 3-D print shops within a specified territory range and a specified transport carrier to ship the selected 3-D print design.

13. The system of claim 1, wherein the optimizing engine uses an algorithm in order to determine the optimal 3-D print offer based on the composite customer account web page data including general product inquiry data, 3-D print design data and 3-D print shop bid data.

14. A system for creating and serving web pages for providing 3-D printed product services, the system comprising:
a) an auction engine for hosting customer account web pages and automatically creating customer account web pages, each customer account web page providing a dynamic composite web page having general product inquiry data, 3-D print design data and 3-D print shop bid data;
b) a design library for storing thousands of 3-D print designs, the design library linked to the auction engine;
c) an optimization engine linked to the auction engine and design library, the optimization engine programmed to:
i) receive a 3-D print design request from the customer and automatically link the customer account web page to the design database having 3-D print designs matching the assigned category;
ii) link to a performance analyzer to analyze the product suggestions to rate the comparable performance characteristics of the product suggestions and automatically insert the product analysis to the customer account web page;
d) the auction engine programmed to:
i) receive a selected 3-D print design from the customer account web page and automatically post on an auction web page the selected 3-D print design for bids from 3-D print shops;
ii) receive bids for the selected 3-D print design from 3-D print shops and automatically insert the bids for display on the customer account web page; and
iii) receive a purchase request from the customer account web page for a 3-D print design order selected by the customer based on the composite customer account web page having 3-D print design data and 3-D print shop bid data and automatically forwarding the 3-D print design order to a corresponding 3-D print shop for completing the order.

15. The system of claim 14 wherein the optimization engine further programmed to:
i) receive a general inquiry from the customer account web page;
ii) automatically assign a category to the general inquiry;
iii) automatically send the general inquiry to networked forums that match the assigned category; and
iv) receive product suggestions from the networked forums and automatically insert the product suggestions to the customer account web page and automatically notifying the customer that a response to the general inquiry has been inserted on the customer account web page.

16. The system of claim 14, wherein the optimization engine posting product suggestions from a first group of networked forum members and automatically inviting a second group of networked forum members for forums related to the category to provide comparisons between the product suggestions from the first group of networked forum member and a second product suggestion from the second group of networked forum members.

17. The system of claim 16, wherein the comparisons include descriptions regarding the desirability and marketability of the second product suggestion.

18. The system of claim 14, wherein the 3-D print shop 3-D printer is linked to the network and capable of communicating with the optimization engine and the 3-D printer provides project status information and product performance information.

19. The system of claim 14, further comprising a payment allocation server for executing a payment transaction in favor of the corresponding 3-D print shop upon shipment of the 3-D print design order to the customer and updating the customer account web page indicating completion of the 3-D print design order.

20. A method for creating and serving web pages for providing 3-D printed product services, the method comprising the steps of:
a) simultaneously hosting hundreds of customer account web pages and automatically creating customer account web pages by an auction server, each customer account web page providing a composite web page having general product inquiry data, 3-D print design data and 3-D print shop bid data;
b) storing thousands of 3-D print designs by a design database linked to the auction server;
c) receiving a 3-D print design request from the customer and automatically linking the customer account web page to the design database having 3-D print designs matching the assigned category, the receiving and linking by an optimization engine linked to the auction server and design database;
d) linking to a performance analyzer and analyzing the product suggestions to rate the comparable performance characteristics of the product suggestions and automatically inserting the product analysis to the customer account web page, the linking and inserting by the optimization engine;
e) receiving a selected 3-D print design from the customer account web page and automatically posting on an auction web page the selected 3-D print design for bids from 3-D print shops, the receiving and posting by the auction server;
f) receiving bids for the selected 3-D print design from 3-D print shops and automatically inserting the bids for display on the customer account web page, the receiving and inserting by the auction server; and
g) receiving a purchase request from the customer account web page for a 3-D print design order selected by the customer based on the composite customer account web page having general product inquiry data, 3-D print design data and 3-D print shop bid data and automatically forwarding the 3-D print design order to a corresponding 3-D print shop for completing the order, the receiving and forwarding by the auction server.

21. The method of claim 20 wherein an optimization engine is provided and facilitates the following steps:
receiving a general inquiry from the customer account web page;
automatically assigning a category to the general inquiry;
automatically sending the general inquiry to networked forums that match the assigned category; and
receiving product suggestions from the networked forums and automatically insert the product suggestions to the customer account web page and automatically notifying the customer that a response to the general inquiry has been inserted on the customer account web page.

22. The method of claim 21, further comprising the steps of posting product suggestions by the optimization engine from a first group of networked forum members and automatically inviting a second group of networked forum members for forums related to the category to provide comparisons between the product suggestions from the first group of networked forum member and a second product suggestion from the second group of networked forum members.

23. The method of claim 22, further comprising the step of linking the 3-D print shop 3-D printer to the network and capable of communicating with the optimization engine and the 3-D printer provides project status information and product performance information.
